(19) United States
(12) Patent Application Publication
(10) Pub. No.: US 2007/0155356 A1
(43) Pub. Date: Jul. 5, 2007

(54) Control system having compound function

(76) Inventor: Cheng-Lung Chang, Taipei (TW)

Correspondence Address: LAW OFFICES OF LAI & ASSOCIATES, P.C., 5800 RANCHESTER, STE. 200, HOUSTON, TX, 77036, US

(21) Appl. No.: 11/306,583

(22) Filed: Jan. 3, 2006

(51) Int. Cl. H04B 1/16

(52) U.S. Cl. 455/343.1

(57) ABSTRACT

A control system having a compound function is disclosed. The control system is used for switching on an electronic apparatus and simultaneously makes the electronic apparatus implement an action required from an instruction signal. The control system uses a transmission body to transmit a compound signal to a receiving unit. The receiving unit transmits a switching signal and the instruction signal to a power control unit and a storage unit respectively after the receiving unit receives the compound signal. The electronic apparatus can be switched by the power control unit. The instruction signal which is temporarily stored in the stored unit is then transmitted to the electronic apparatus that makes the electronic apparatus to implement an action required from the instruction signal.

### FIELD OF THE INVENTION

The present invention relates to a control system having compound function and, more particularly, to utilizing a transmission body to transmit a compound signal which comprises a switching signal and an instruction signal for implementing functions selected while switching an electrical apparatus.

### BACKGROUND OF THE INVENTION

A remote controller can be added with an electrical apparatus that provided wirelesses functions to the electrical apparatus to increase conveniences to a user in operating. In FIG. 1 and FIG. 2, block diagrams of using a conventional remote controller to control an electrical apparatus are illustrated. The remote controller 11 comprises a sending unit 113, a power bottom 111, and a function key 112. The electrical apparatus 12 comprises a receiving unit 121, a power supply unit 122, and a processor 123. As shown in FIG. 1, an activating signal is transmitted through the power button 111 to the sending unit 113. The activating signal is then transmitted by the sending unit 113 which uses a wireless transmission protocol to the receiving unit 121. The activating signal is transmitted by the receiving unit 121 to the power supply unit 122 to activate the electrical apparatus 12. As shown in FIG. 2, a function signal is transmitted by the function key 112 to the sending unit 113. The function signal is transmitted by the sending unit 113 which uses a wireless transmission protocol to the receiving unit 121 of the electrical apparatus 12. The function signal is transmitted by the receiving unit 121 to the processor 123 to implement a function selected. However, the power button set on the remote controller must first be pressed to activate the electrical apparatus prior to further selecting the function key. The convenience can be improved if the key selections repeated can be combined.

Therefore, the present invention utilizes a control system having a compound function to transmit a compound signal which comprises a switching signal and an instruction signal and implement functions selected simultaneously while switching on an electrical apparatus.

### SUMMARY OF THE INVENTION

When an electrical apparatus is switched by a remote controller, first, a power button must be pressed and then function keys are then selected to be able to switch functions of the electrical apparatus. The aforesaid way is inconvenient to users. Accordingly, the object of the present invention is to switch the electrical apparatus through a transmission body, a receiving unit, a power control unit, and a storage unit and implement an action required of the electrical apparatus via an instruction signal simultaneously.

According to the present invention of a control system having a compound function, the control system is used to switch on the electrical apparatus and implement an action required of the instruction signal simultaneously. The control system comprises a transmission body, a receiving unit, a power control unit, and a storage unit. A compound signal which includes an instruction signal and a switching signal is produced by the transmission body. The compound signal is transmitted through a wireless transmission protocol to the receiving unit. If the electrical apparatus is in a sleep mode, powered off or on standby status, the switching signal and the instruction signal can be separated by the receiving unit from the compound signal. The power control unit is electrically connected to a power supply unit of the electrical apparatus. The power supply unit can be controlled by the switching signal to switch the electrical apparatus. The instruction signal temporarily stored in the storage unit is transmitted to the electrical apparatus after switching the electrical apparatus that enables the electrical apparatus to implement actions required from the instruction signal.

Other features and advantages of the present invention and variations thereof will become apparent from the following description, drawings, and claims.

### BRIEF DESCRIPTION OF THE DRAWINGS

FIG. 1 and FIG. 2 are block diagrams of a conventional remote controller controlling an electrical apparatus; and

FIG. 3 is a block diagram of a control system having a compound function according to an embodiment of the present invention.

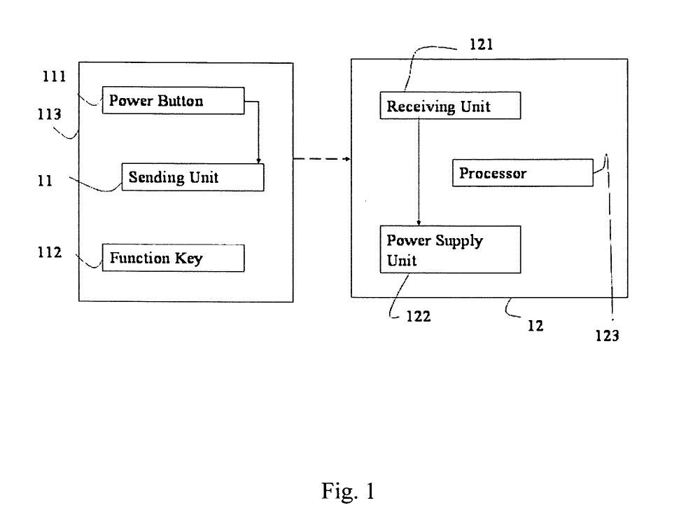

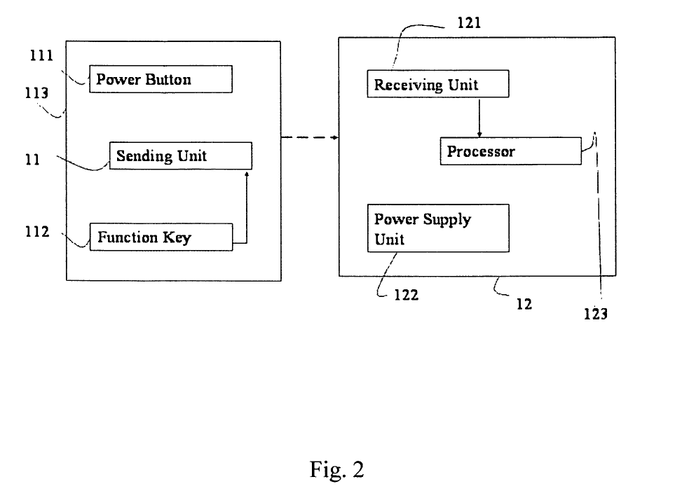

### DETAILED DESCRIPTION OF THE PREFERRED EMBODIMENTS

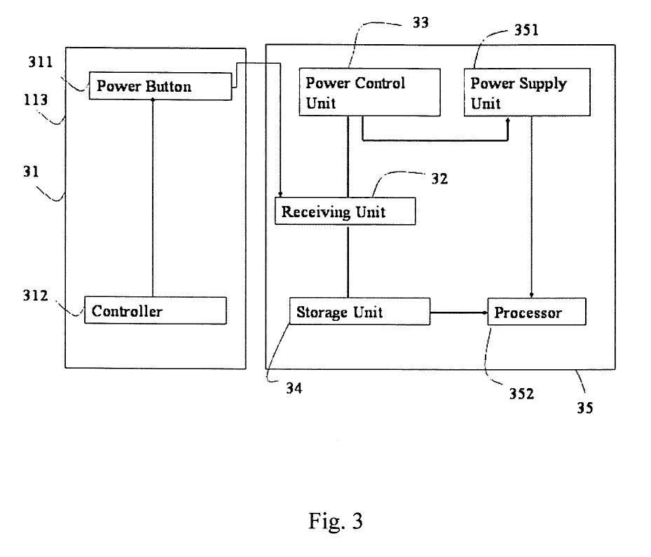

Referring to FIG. 3, a block diagram of a control system having a compound function according to an embodiment of the present invention is disclosed. The control system comprises a transmission body 31 and an electrical apparatus 35. The transmission body 31 comprises a transmission unit 311 and a controller 312. The electrical apparatus 35 comprises a receiving unit 32, a power control unit 33, a storage unit 34, a power supply unit 351, and a processor 352. A switching signal and an instruction signal of a compound signal are transmitted by the controller 312 to the transmission unit 311. The compound signal is then transmitted by the transmission unit 311 which utilizes a wireless transmission protocol to the receiving unit 32. If the electrical apparatus is in a sleep mode, powered off or on standby status, the switching signal and the instruction signal can be separated by the receiving unit 32 from the compound signal when the compound signal is received by the receiving unit 32. The switching signal and the instruction signal are transmitted to the power control unit 33 and the storage unit 34 respectively. A power is provided by the power control unit 33 to the processor 352 based on the switching signal in order to switch the processor 352. Afterwards, the instruction signal temporarily stored in the storage unit 34 is transmitted to the processor 352. The contents of the instruction signal are set by the function keys and the predetermined keys of the controller 312 based on the functions of the electrical apparatus. 35

Although the features and advantages of the embodiments according to the preferred invention are disclosed, it is not limited to the embodiments described above, but encompasses any and all modifications and changes within the spirit and scope of the following claims.

What is claimed is:

1. A control system having a compound function, comprising:
a transmission body for transmitting a compound signal;
a receiving unit for receiving the compound signal, and for transmitting an instruction signal and a switching signal simultaneously based on a use status of an electrical apparatus.
a power control unit for receiving the switching signal to switch the electrical apparatus; and
a storage unit for receiving and temporarily storing the instruction signal, after switching the electrical apparatus, a function being implemented by the electrical apparatus based on the instruction signal.

2. The control system of claim 1, wherein the transmission body uses a wireless transmission protocol for transmitting the compound signal to the receiving unit.

3. The control system of claim 1, wherein the receiving unit uses a wireless transmission protocol for receiving the compound signal from the transmission body.

4. The control system of claim 1, wherein the compound signal comprises the instruction signal and the switching signal.

5. The control system of claim 1, wherein the use status is a sleep mode.

6. The control system of claim 1, wherein the use status is a power off status.

7. The control system of claim 1, wherein the use status is a standby status.

8. The control system of claim 1, wherein the instruction signal is used to order the electrical apparatus to implement the function.

9. The control system of claim 1, wherein the power control unit utilizes the switching signal to switch the electrical apparatus.

10. The control system of claim 1, wherein the power control unit is electrically connected to a power supply unit of the electrical apparatus.

11. The control system of claim 1, wherein the instruction signal is embedded by the transmission body.

12. The control system of claim 1, wherein the instruction signal is predetermined based on the functions of the electrical apparatus.
